(19) United States
(12) Patent Application Publication
(10) Pub. No.: US 2020/0191975 A1
(43) Pub. Date: Jun. 18, 2020

(54) INFORMATION PROCESSING APPARATUS, SELF-POSITION ESTIMATION METHOD, AND PROGRAM

(71) Applicant: Sony Corporation, Tokyo (JP)

(72) Inventors: Ryo Watanabe, Tokyo (JP); Dai Kobayashi, Tokyo (JP); Masataka Toyoura, Tokyo (JP)

(73) Assignee: Sony Corporation, Tokyo (JP)

(21) Appl. No.: 16/642,387

(22) PCT Filed: Sep. 3, 2018
(86) PCT No.: PCT/JP2018/032624

§ 371 Date: Feb. 27, 2020

(30) Foreign Application Priority Data
Sep. 5, 2017 (JP) 2017-169967

(51) Int. Cl. G01S 19/24; G06T 7/70; G02B 13/06

(52) U.S. Cl. CPC G01S 19/24; G06T 7/70; G06T 2207/30252; G06T 2207/10004; G02B 13/06

(57) ABSTRACT

There is provided methods and apparatus for estimating a position of a movable object based on a received satellite signal. A range of use of an acquired image of an environment around the movable object is determined based on a received satellite signal. An estimated position of the movable object is determined based on the range of use of the acquired image and a key frame from a key frame map.

### TECHNICAL FIELD

The present technology relates to an information processing apparatus, a self-position estimation method, and a program, and particularly to an information processing apparatus, a self-position estimation method, and a program that estimate a self-position of a movable object by using an image captured using a fish-eye lens.

### CROSS REFERENCE TO RELATED APPLICATIONS

This application claims the benefit of Japanese Priority Patent Application JP 2017-169967 filed Sep. 5, 2017, the entire contents of which are incorporated herein by reference.

### BACKGROUND ART

In the past, a technology in which an autonomous mobile robot with a ceiling camera mounted on the top portion thereof, which includes a fish-eye lens, autonomously moves to a charging device on the basis of a position of a marker on the charging device detected by using an image captured by the ceiling camera has been proposed (see, for example, Patent Literature 1).

### CITATION LIST

### Patent Literature

PTL 1: Japanese Patent Application Laid-open No. 2004-303137

### SUMMARY OF INVENTION

### Technical Problem

However, in Patent Literature 1, improvement of the accuracy of estimating a self-position of the robot by using an image captured by the ceiling camera including a fish-eye lens without using a marker is not considered.

The present technology has been made in view of the above circumstances to improve the accuracy of estimating a self-position of a movable object by using an image captured using a fish-eye lens.

### Solution to Problem

According to the present disclosure, there is provided a computerized method for determining an estimated position of a movable object based on a received satellite signal. The method comprises determining, based on a received satellite signal, a range of use of an acquired image of an environment around the movable object, and determining an estimated position of the movable object based on the range of use of the acquired image and a key frame from a key frame map.

According to the present disclosure, there is provided an apparatus for determining an estimated position of a movable object based on a received satellite signal. The apparatus comprises a processor in communication with a memory. The processor is configured to execute instructions stored in the memory that cause the processor to determine, based on a received satellite signal, a range of use of an acquired image of an environment around the movable object, and determine an estimated position of the movable object based on the range of use and a key frame from a key frame map.

According to the present disclosure, there is provided a non-transitory computer-readable storage medium comprising computer-executable instructions that, when executed by a processor, perform a method for determining an estimated position of a movable object based on a received satellite signal. The method comprises determining, based on a received satellite signal, a range of use of an acquired image of an environment around the movable object, and determining an estimated position of the movable object based on the range of use and a key frame from a key frame map.

According to the present disclosure, there is provided a movable object configured to determine an estimated position of the movable object based on a received satellite signal. The movable object comprises a processor in communication with a memory. The processor is configured to execute instructions stored in the memory that cause the processor to determine, based on a received satellite signal, a range of use of an acquired image of an environment around the movable object, and determine an estimated position of the movable object based on the range of use and a key frame from a key frame map.

### Advantageous Effects of Invention

According to the embodiment of the present technology, it is possible to improve the accuracy of estimating a self-position of a movable object by using an image captured using a fish-eye lens.

It should be noted that the effect described here is not necessarily limitative and may be any effect described in the present disclosure.

### BRIEF DESCRIPTION OF DRAWINGS

FIG. 1 is a block diagram schematically showing a functional configuration example of a vehicle control system to which an embodiment of the present technology can be applied.

FIG. 2 is a block diagram showing a self-position estimation system to which an embodiment of the present technology is applied.

FIG. 3 is a diagram showing an example of a position where a fish-eye camera is placed in a vehicle.

FIG. 4 is a flowchart describing processing of generating a key frame.

FIG. 5 is a diagram showing a first example of a reference image.

FIG. 6 is a diagram showing a second example of the reference image.

FIG. 7 is a diagram showing a third example of the reference image.

FIG. 8 is a flowchart describing processing of estimating a self-position.

FIG. 9 is a flowchart describing a method of setting a range of use.

FIG. 10 is a diagram showing an example of a position where a fish-eye camera is placed in a robot.

FIG. 11 is a diagram showing an example of a position where a fish-eye camera is placed in a drone.

FIG. 12 is a diagram showing a configuration example of a computer.

### DESCRIPTION OF EMBODIMENTS

Hereinafter, embodiments for carrying out the present technology will be described. Descriptions will be made in the following order.

1. Configuration Example of Vehicle Control System

2. Embodiments

3. Modified Examples

4. Others

<<1. Configuration Example of Vehicle Control System>>

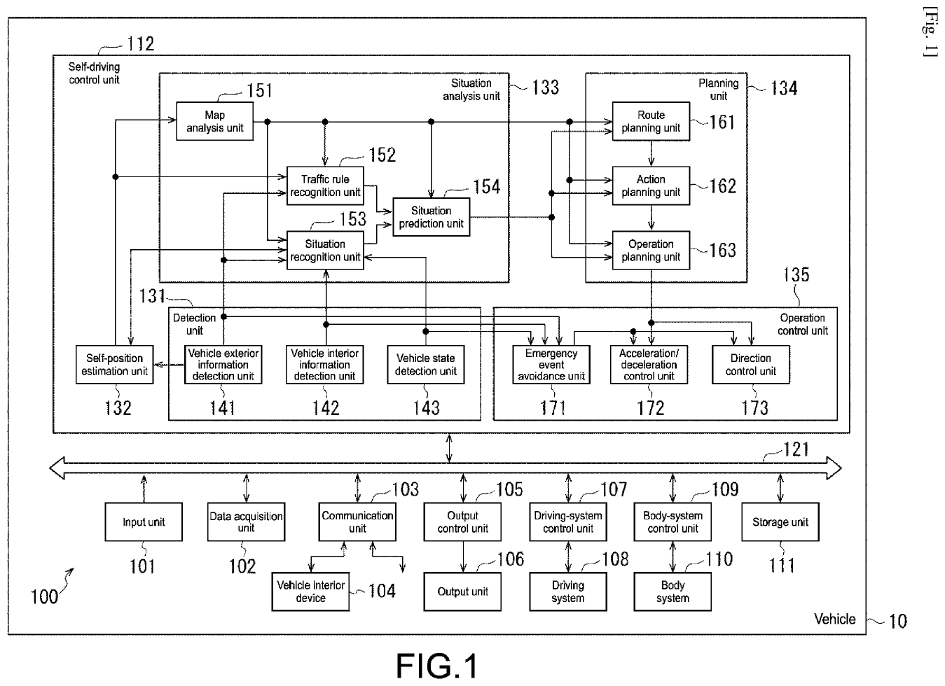

FIG. 1 is a block diagram schematically showing a functional configuration example of a vehicle control system 100 as an example of a movable object control system to which an embodiment of the present technology can be applied.

The vehicle control system 100 is a system that is installed in a vehicle 10 and performs various types of control on the vehicle 10. Note that when distinguishing the vehicle 10 with another vehicle, it is referred to as the own car or own vehicle.

The vehicle control system 100 includes an input unit 101, a data acquisition unit 102, a communication unit 103, a vehicle interior device 104, an output control unit 105, an output unit 106, a driving-system control unit 107, a driving system 108, a body-system control unit 109, a body system 110, a storage unit 111, and an self-driving control unit 112. The input unit 101, the data acquisition unit 102, the communication unit 103, the output control unit 105, the driving-system control unit 107, the body-system control unit 109, the storage unit 111, and the self-driving control unit 112 are connected to each other via a communication network 121. The communication network 121 includes an on-vehicle communication network or a bus conforming to an arbitrary standard such as CAN (Controller Area Network), LIN (Local Interconnect Network), LAN (Local Area Network), and FlexRay (registered trademark). Note that the respective units of the vehicle control system 100 are directly connected to each other not via the communication network 121 in some cases.

Note that in the case where the respective units of the vehicle control system 100 perform communication via the communication network 121, description of the communication network 121 will be omitted below. For example, a case where the input unit 101 and the self-driving control unit 112 perform communication via the communication network 121 will be described simply as “the input unit 101 and the self-driving control unit 112 perform communication with each other”.

The input unit 101 includes a device for a passenger to input various kinds of data, instructions, and the like. For example, the input unit 101 includes an operation device such as a touch panel, a button, a microphone, a switch, and a lever, and an operation device that can be operated by a method other than the manual operation, such as voice and gesture. Further, for example, the input unit 101 may be a remote control apparatus using infrared rays or other radio waves, or external connection device such as a mobile device and a wearable device, which supports the operation of the vehicle control system 100. The input unit 101 generates an input signal on the basis of the data or instruction input by the passenger, and supplies the input signal to the respective units of the vehicle control system 100.

The data acquisition unit 102 includes various sensors for acquiring data to be used for processing performed in the vehicle control system 100, or the like, and supplies the acquired data to the respective units of the vehicle control system 100.

For example, the data acquisition unit 102 includes various sensors for detecting the state and the like of the vehicle 10. Specifically, for example, the data acquisition unit 102 includes a gyro sensor, an acceleration sensor, an inertial measurement unit (IMU), and sensors for detecting the operational amount of an accelerator pedal, the operational amount of a brake pedal, the steering angle of a steering wheel, the engine r.p.m., the motor r.p.m., or the wheel rotation speed.

Further, for example, the data acquisition unit 102 includes various sensors for detecting information outside the vehicle 10. Specifically, for example, the data acquisition unit 102 includes an imaging apparatus such as a ToF (Time Of Flight) camera, a stereo camera, a monocular camera, an infrared camera, and other cameras. Further, for example, the data acquisition unit 102 includes an environment sensor for detecting weather, a meteorological phenomenon, or the like, and an ambient information detection sensor for detecting an object in the vicinity of the vehicle 10. The environment sensor includes, for example, a raindrop sensor, a fog sensor, a sunshine sensor, a snow sensor, or the like. The ambient information detection sensor includes, for example, an ultrasonic sensor, a radar, a LiDAR (Light Detection and Ranging, Laser Imaging Detection and Ranging), a sonar, or the like.

Further, for example, the data acquisition unit 102 includes various sensors for detecting the current position of the vehicle 10. Specifically, for example, the data acquisition unit 102 includes a GNSS receiver that receives a GNSS signal from a GNSS (Global Navigation Satellite System) satellite, or the like.

Further, for example, the data acquisition unit 102 includes various sensors for detecting vehicle interior information. Specifically, for example, the data acquisition unit 102 includes an imaging apparatus that captures an image of a driver, a biological sensor for detecting biological information regarding the driver, a microphone for collecting sound in the interior of the vehicle, and the like. The biological sensor is provided, for example, on a seating surface, a steering wheel, or the like, and detects biological information regarding the passenger sitting on a seat or the driver holding the steering wheel.

The communication unit 103 communicates with the vehicle interior device 104, and various devices, a server, and a base station outside the vehicle, and the like to transmit data supplied from the respective units of the vehicle control system 100 or supply the received data to the respective units of the vehicle control system 100. Note that the communication protocol supported by the communication unit 103 is not particularly limited, and the communication unit 103 may support a plurality of types of communication protocols.

For example, the communication unit 103 performs wireless communication with the vehicle interior device 104 via a wireless LAN, Bluetooth (registered trademark), NFC (Near Field Communication), WUSB (Wireless USB), or the like. Further, for example, the communication unit 103 performs wired communication with the vehicle interior device 104 by USB (Universal Serial Bus), HDMI (High-Definition Multimedia Interface), MHL (Mobile High-definition Link), or the like via a connection terminal (not shown) (and, if necessary, a cable).

Further, for example, the communication unit 103 communicates with a device (e.g., an application server or a control server) on an external network (e.g., the Internet, a cloud network, or a network unique to the operator) via a base station or an access point. Further, for example, the communication unit 103 communicates with a terminal (e.g., a terminal of a pedestrian or a shop, and an MTC (Machine Type Communication) terminal) in the vicinity of the vehicle 10 by using P2P (Peer To Peer) technology. Further, for example, the communication unit 103 performs V2X communication such as vehicle-to-vehicle communication, vehicle-to-infrastructure communication, communication between the vehicle 10 and a house, and vehicle-to-pedestrian communication. Further, for example, the communication unit 103 includes a beacon reception unit, receives via radio wave or electromagnetic waves transmitted from a radio station or the like placed on a road, and acquires information such as information of the current position, traffic congestion, traffic regulation, or necessary time.

The vehicle interior device 104 includes, for example, a mobile device or a wearable device owned by the passenger, an information device carried in or attached to the vehicle 10, a navigation apparatus that searches for a path to an arbitrary destination.

The output control unit 105 controls output of various types of information regarding the passenger of the vehicle 10 or information outside the vehicle 10. For example, the output control unit 105 generates an output signal containing at least one of visual information (e.g., image data) and auditory information (e.g., audio data), supplies the signal to the output unit 106, and thereby controls output of the visual information and the auditory information from the output unit 106. Specifically, for example, the output control unit 105 combines data of images captured by different imaging apparatuses of the data acquisition unit 102 to generate an overhead image, a panoramic image, or the like, and supplies an output signal containing the generated image to the output unit 106. Further, for example, the output control unit 105 generates audio data containing warning sound, a warning message, or the like for danger such as collision, contact, and entry into a dangerous zone, and supplies an output signal containing the generated audio data to the output unit 106.

The output unit 106 includes an apparatus capable of outputting visual information or auditory information to the passenger of the vehicle 10 or the outside of the vehicle 10. For example, the output unit 106 includes a display apparatus, an instrument panel, an audio speaker, a headphone, a wearable device such as a spectacle-type display to be attached to the passenger, a projector, a lamp, and the like. The display apparatus included in the output unit 106 is not limited to the apparatus including a normal display, and may be, for example, an apparatus for displaying visual information within the field of view of the driver, such as a head-up display, a transmissive display, and an apparatus having an AR (Augmented Reality) display function.

The driving-system control unit 107 generates various control signals, supplies the signals to the driving system 108, and thereby controls the driving system 108. Further, the driving-system control unit 107 supplies the control signal to the respective units other than the driving system 108 as necessary, and notifies the control state of the driving system 108, and the like.

The driving system 108 includes various apparatuses related to the driving system of the vehicle 10. For example, the driving system 108 includes a driving force generation apparatus for generating a driving force, such as an internal combustion engine and a driving motor, a driving force transmission mechanism for transmitting the driving force to wheels, a steering mechanism for adjusting the steering angle, a braking apparatus for generating a braking force, an ABS (Antilock Brake System), an ESC (Electronic Stability Control), an electric power steering apparatus, for example.

The body-system control unit 109 generates various control signals, supplies the signals to the body system 110, and thereby controls the body system 110. Further, the body-system control unit 109 supplies the control signals to the respective units other than the body system 110 as necessary, and notifies the control state of the body system 110, for example.

The body system 110 includes various body-system apparatuses equipped on the vehicle body. For example, the body system 110 includes a keyless entry system, a smart key system, a power window apparatus, a power seat, a steering wheel, an air conditioner, various lamps (e.g., a head lamp, a back lamp, a brake lamp, a blinker, and a fog lamp), and the like.

The storage unit 111 includes, for example, a magnetic storage device such as a ROM (Read Only Memory), a RAM (Random Access Memory), and an HDD (Hard Disc Drive), a semiconductor storage device, an optical storage device, and a magneto-optical storage device, or the like. The storage unit 111 stores various programs, data, and the like to be used by the respective units of the vehicle control system 100. For example, the storage unit 111 stores map data of a three-dimensional high precision map such as a dynamic map, a global map that has a lower precision and covers a wider area than the high precision map, and a local map containing information regarding the surroundings of the vehicle 10.

The self-driving control unit 112 performs control on self-driving such as autonomous driving and driving assistance. Specifically, for example, the self-driving control unit 112 is capable of performing coordinated control for the purpose of realizing the ADAS (Advanced Driver Assistance System) function including avoiding collision of the vehicle 10, lowering impacts of the vehicle collision, follow-up driving based on a distance between vehicles, constant speed driving, a collision warning for the vehicle 10, a lane departure warning for the vehicle 10, or the like. Further, for example, the self-driving control unit 112 performs coordinated control for the purpose of realizing self-driving, i.e., autonomous driving without the need of drivers' operations, and the like. The self-driving control unit 112 includes a detection unit 131, a self-position estimation unit 132, a situation analysis unit 133, a planning unit 134, and an operation control unit 135.

The detection unit 131 detects various types of information necessary for control of self-driving. The detection unit 131 includes a vehicle exterior information detection unit 141, a vehicle interior information detection unit 142, and a vehicle state detection unit 143.

The vehicle exterior information detection unit 141 performs processing of detecting information outside the vehicle 10 on the basis of the data or signal from the respective units of the vehicle control system 100. For example, the vehicle exterior information detection unit 141 performs processing of detecting, recognizing, and following-up an object in the vicinity of the vehicle 10, and processing of detecting the distance to the object. The object to be detected includes, for example, a vehicle, a human, an obstacle, a structure, a road, a traffic signal, a traffic sign, and a road sign. Further, for example, the vehicle exterior information detection unit 141 performs processing of detecting the ambient environment of the vehicle 10. The ambient environment to be detected includes, for example, weather, temperature, humidity, brightness, condition of a road surface, and the like. The vehicle exterior information detection unit 141 supplies the data indicating the results of the detection processing to the self-position estimation unit 132, a map analysis unit 151, a traffic rule recognition unit 152, and a situation recognition unit 153 of the situation analysis unit 133, and an emergency event avoidance unit 171 of the operation control unit 135, for example.

The vehicle interior information detection unit 142 performs processing of detecting vehicle interior information on the basis of the data or signal from the respective units of the vehicle control system 100. For example, the vehicle interior information detection unit 142 performs processing of authenticating and recognizing the driver, processing of detecting the state of the driver, processing of detecting the passenger, and processing of detecting the environment inside the vehicle. The state of the driver to be detected includes, for example, physical condition, arousal degree, concentration degree, fatigue degree, line-of-sight direction, and the like. The environment inside the vehicle to be detected includes, for example, temperature, humidity, brightness, smell, and the like. The vehicle interior information detection unit 142 supplies the data indicating the results of the detection processing to the situation recognition unit 153 of the situation analysis unit 133, and the emergency event avoidance unit 171 of the operation control unit 135, for example.

The vehicle state detection unit 143 performs processing of detecting the state of the vehicle 10 on the basis of the data or signal from the respective units of the vehicle control system 100. The state of the vehicle 10 to be detected includes, for example, speed, acceleration, steering angle, presence/absence and content of abnormality, the state of the driving operation, position and inclination of the power seat, the state of the door lock, the state of other on-vehicle devices, and the like. The vehicle state detection unit 143 supplies the data indicating the results of the detection processing to the situation recognition unit 153 of the situation analysis unit 133, and the emergency event avoidance unit 171 of the operation control unit 135, for example.

The self-position estimation unit 132 performs processing of estimating a position, a posture, and the like of the vehicle 10 on the basis of the data or signal from the respective units of the vehicle control system 100, such as the vehicle exterior information detection unit 141 and the situation recognition unit 153 of the situation analysis unit 133. Further, the self-position estimation unit 132 generates a local map (hereinafter, referred to as the self-position estimation map) to be used for estimating a self-position as necessary. The self-position estimation map is, for example, a high precision map using a technology such as SLAM (Simultaneous Localization and Mapping). The self-position estimation unit 132 supplies the data indicating the results of the estimation processing to the map analysis unit 151, the traffic rule recognition unit 152, and the situation recognition unit 153 of the situation analysis unit 133, for example. Further, the self-position estimation unit 132 causes the storage unit 111 to store the self-position estimation map.

The situation analysis unit 133 performs processing of analyzing the situation of the vehicle 10 and the surroundings thereof. The situation analysis unit 133 includes the map analysis unit 151, the traffic rule recognition unit 152, the situation recognition unit 153, and a situation prediction unit 154.

The map analysis unit 151 performs processing of analyzing various maps stored in the storage unit 111 while using the data or signal from the respective units of the vehicle control system 100, such as the self-position estimation unit 132 and the vehicle exterior information detection unit 141, as necessary, and thereby builds a map containing information necessary for self-driving processing. The map analysis unit 151 supplies the built map to the traffic rule recognition unit 152, the situation recognition unit 153, the situation prediction unit 154, and a route planning unit 161, an action planning unit 162, and an operation planning unit 163 of the planning unit 134, for example.

The traffic rule recognition unit 152 performs processing of recognizing a traffic rule in the vicinity of the vehicle 10 on the basis of the data or signal from the respective units of the vehicle control system 100, such as the self-position estimation unit 132, the vehicle exterior information detection unit 141, and the map analysis unit 151. By this recognition processing, for example, the position and state of the traffic signal in the vicinity of the vehicle 10, content of the traffic regulation in the vicinity of the vehicle 10, a drivable lane, and the like are recognized. The traffic rule recognition unit 152 supplies the data indicating the results of the recognition processing to the situation prediction unit 154 and the like.

The situation recognition unit 153 performs processing of recognizing the situation regarding the vehicle 10 on the basis of the data or signal from the respective units of the vehicle control system 100, such as the self-position estimation unit 132, the vehicle exterior information detection unit 141, the vehicle interior information detection unit 142, the vehicle state detection unit 143, and the map analysis unit 151. For example, the situation recognition unit 153 performs processing of recognizing the situation of the vehicle 10, the situation of the surroundings of the vehicle 10, the state of the driver of the vehicle 10, and the like. Further, the situation recognition unit 153 generates a local map (hereinafter, referred to as the situation recognition map) to be used for recognizing the situation of the surroundings of the vehicle 10, as necessary. The situation recognition map is, for example, an occupancy grid map.

The situation of the vehicle 10 to be recognized includes, for example, the position, posture, and movement (e.g., speed, acceleration, and moving direction) of the vehicle 10, presence/absence of and content of abnormality, and the like. The situation of the surroundings of the vehicle 10 to be recognized includes, for example, the type and position of a stationary object of the surroundings, the type, position, and movement (e.g., speed, acceleration, and moving direction) of a movable body of the surroundings, the configuration a road of the surroundings, the condition of a road surface, weather, temperature, humidity, and brightness of the surroundings, and the like. The state of the driver to be recognized includes, for example, physical condition, arousal degree, concentration degree, fatigue degree, movement of the line of sight, driving operation, and the like.

The situation recognition unit 153 supplies the data (including the situation recognition map as necessary) indicating the results of the recognition processing to the self-position estimation unit 132 and the situation prediction unit 154, for example. Further, the situation recognition unit 153 causes the storage unit 111 to store the situation recognition map.

The situation prediction unit 154 performs processing of predicting the situation regarding the vehicle 10 on the basis of the data or signal from the respective units of the vehicle control system 100, such as the map analysis unit 151, the traffic rule recognition unit 152 and the situation recognition unit 153. For example, the situation prediction unit 154 performs processing of predicting the situation of the vehicle 10, the situation of the surroundings of the vehicle 10, the state of the driver, and the like.

The situation of the vehicle 10 to be predicted includes, for example, the behavior of the vehicle 10, occurrence of abnormality, a drivable distance, and the like. The situation of the surroundings of the vehicle 10 to be predicted includes, for example, the behavior of a movable body in the vicinity of the vehicle 10, change of the state of a traffic signal, change of the environment such as weather, and the like. The state of the driver to be predicted includes, for example, the behavior, physical condition, and the like of the driver.

The situation prediction unit 154 supplies the data indicating the results of the prediction processing to, for example, the route planning unit 161, the action planning unit 162, and the operation planning unit 163 of the planning unit 134, together with the data from the traffic rule recognition unit 152 and the situation recognition unit 153.

The route planning unit 161 plans a route to a destination on the basis of the data or signal from the respective units of the vehicle control system 100, such as the map analysis unit 151 and the situation prediction unit 154. For example, the route planning unit 161 sets a route from the current position to the specified destination on the basis of a global map. Further, for example, the route planning unit 161 changes the route as appropriate on the basis of traffic congestion, the accident, traffic regulation, conditions of construction or the like, the physical condition of the driver, and the like. The route planning unit 161 supplies the data indicating the planned route to the action planning unit 162, for example.

The action planning unit 162 plans an action of the vehicle 10 for safely driving on the route planned by the route planning unit 161 within the planned time period on the basis of the data or signal from the respective units of the vehicle control system 100, such as the map analysis unit 151 and the situation prediction unit 154. For example, the action planning unit 162 makes plans for starting, stopping, travelling directions (e.g., forward, backward, turning left, turning right, and changing direction), driving lane, driving speed, overtaking, and the like. The action planning unit 162 supplies the data indicating the planned action of the vehicle 10 to the operation planning unit 163, for example.

The operation planning unit 163 plans the operation of the vehicle 10 for realizing the action planned by the action planning unit 162 on the basis of the data or signal from the respective units of the vehicle control system 100, such as the map analysis unit 151 and the situation prediction unit 154. For example, the operation planning unit 163 makes plans for acceleration, deceleration, running track, and the like. The operation planning unit 163 supplies the data indicating the planned operation of the vehicle 10 to an acceleration/deceleration control unit 172 and a direction control unit 173 of the operation control unit 135, for example.

The operation control unit 135 controls the operation of the vehicle 10. The operation control unit 135 includes the emergency event avoidance unit 171, the acceleration/deceleration control unit 172, and the direction control unit 173.

The emergency event avoidance unit 171 performs processing of detecting an emergency event such as collision, contact, entry into a dangerous zone, abnormality of the driver, and abnormality of the vehicle 10 on the basis of the detection results by the vehicle exterior information detection unit 141, the vehicle interior information detection unit 142, and the vehicle state detection unit 143. In the case of detecting occurrence of an emergency event, the emergency event avoidance unit 171 plans the operation (such as sudden stop and sudden turn) of the vehicle 10 for avoiding the emergency event. The emergency event avoidance unit 171 supplies the data indicating the planned operation of the vehicle 10 to the acceleration/deceleration control unit 172 and the direction control unit 173, for example.

The acceleration/deceleration control unit 172 performs acceleration/deceleration control for realizing the operation of the vehicle 10 planned by the operation planning unit 163 or the emergency event avoidance unit 171. For example, the acceleration/deceleration control unit 172 calculates a control target value of a driving-force generation apparatus or a braking apparatus for realizing the planned acceleration, deceleration, or sudden stop, and supplies a control command indicating the calculated control target value to the driving-system control unit 107.

The direction control unit 173 controls the direction for realizing the operation of the vehicle 10 planned by the operation planning unit 163 or the emergency event avoidance unit 171. For example, the direction control unit 173 calculates a control target value of a steering mechanism for realizing the running track or sudden turn planned by the operation planning unit 163 or the emergency event avoidance unit 171, and supplies a control command indicating the calculated control target value to the driving-system control unit 107.

<<2. Embodiments>>

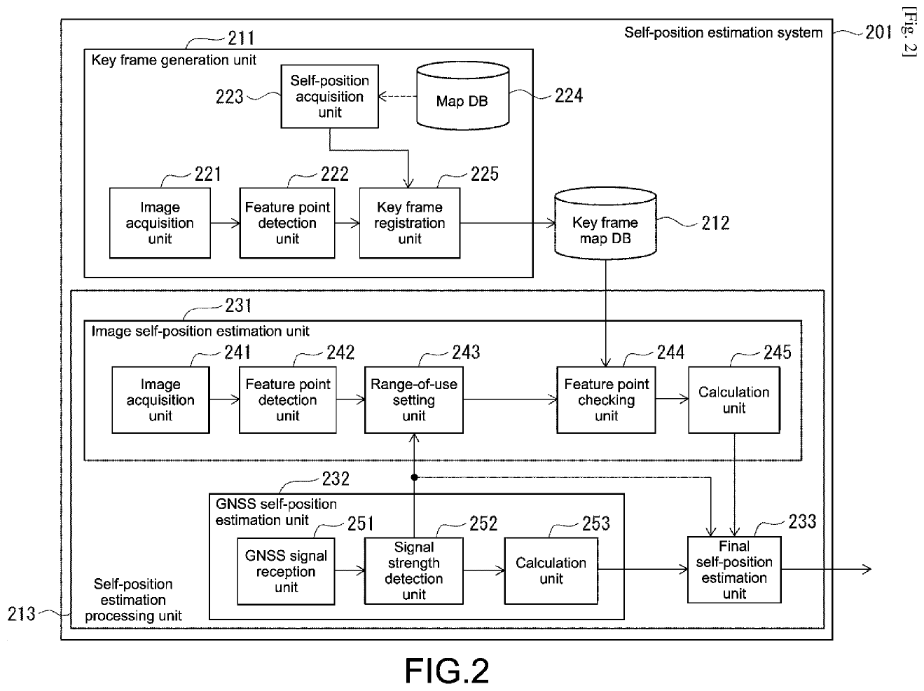

An embodiment of the present technology will be described with reference to FIG. 2 to FIG. 11.

Note that the first embodiment mainly relates to processing by a self-position estimation unit 132 and a vehicle exterior information detection unit 141 of the vehicle control system 100 shown in FIG. 1.

<Configuration Example of Self-Position Estimation System>

FIG. 2 is a block diagram showing a configuration example of self-position estimation system 201 as a self-position estimation system to which an embodiment of the present technology is applied.

The self-position estimation system 201 performs self-position estimation of the vehicle 10 to estimate a position and posture of the vehicle 10.

The self-position estimation system 201 includes a key frame generation unit 211, a key frame map DB (database) 212, and a self-position estimation processing unit 213.

The key frame generation unit 211 performs processing of generating a key frame constituting a key frame map.

Note that the key frame generation unit 211 does not necessarily need to be provided on the vehicle 10. For example, the key frame generation unit 211 may be provided on a vehicle different from the vehicle 10, and the different vehicle may be used to generate a key frame.

Note that an example of a case where the key frame generation unit 211 is provided on a vehicle (hereinafter, referred to as the map generation vehicle) different from the vehicle 10 will be described below.

The key frame generation unit 211 includes an image acquisition unit 221, a feature point detection unit 222, a self-position acquisition unit 223, a map DB (database) 224, and a key frame registration unit 225. Note that the map DB 224 does not necessarily need to be provided, and is provided on the key frame generation unit 211 as necessary.

The image acquisition unit 221 includes a fish-eye camera capable of capturing an image at an angle of view of 180 degrees or more by using a fish-eye lens. As will be described later, the image acquisition unit 221 captures an image around (360 degrees) the upper side of the map generation vehicle, and supplies the resulting image (hereinafter, referred to as the reference image) to the feature point detection unit 222.

The feature point detection unit 222 performs processing of detecting a feature point of the reference image, and supplies data indicating the detection results to the key frame registration unit 225.

The self-position acquisition unit 223 acquires data indicating the position and posture of the map generation vehicle in a map coordinate system, and supplies the acquired data to the key frame registration unit 225.

Note that as the method of acquiring the data indicating the position and posture of the map generation vehicle, an arbitrary method can be used. For example, at least one of a GNSS (Global Navigation Satellite System) signal that is a satellite signal from a navigation satellite, a geomagnetic sensor, wheel odometry, and SLAM (Simultaneous Localization and Mapping) is used for acquiring data indicating the position and posture of the map generation vehicle. Further, as necessary, map data stored in the map DB 224 is used.

The map DB 224 is provided as necessary, and stores map data to be used in the case where the self-position acquisition unit 223 acquires data indicating the position and posture of the map generation vehicle.

The key frame registration unit 225 generates a key frame, and registers the generated key frame in the key frame map DB 212. The key frame contains, for example, data indicating the position and feature amount in an image coordinate system of each feature point detected in the reference image, and data indicating the position and posture of the map generation vehicle in a map coordinate system at the time when the reference image is captured (i.e., position and posture at which the reference image is captured).

Note that hereinafter, the position and posture of the map generation vehicle at the time when the reference image used for creating the key frame is captured will be also referred to simply as the position and posture of the key frame.

The key frame map DB 212 stores a key frame map containing a plurality of key frames based on a plurality of reference images captured at each area while the map generation vehicle runs.

Note that the number of map generation vehicles to be used for creating the key frame map does not necessarily need to be one, and may be two or more.

Further, the key frame map DB 212 does not necessarily need to be provided on the vehicle 10, and may be provided on, for example, a server. In this case, for example, the vehicle 10 refers to or downloads the key frame map stored in the key frame map DB 212 before or while running.

The self-position estimation processing unit 213 is provided on the vehicle 10, and performs processing of estimating a self-position of the vehicle 10. The self-position estimation processing unit 213 includes an image self-position estimation unit 231, a GNSS self-position estimation unit 232, and a final self-position estimation unit 233.

The image self-position estimation unit 231 performs self-position estimation processing by performing feature-point matching between an image around the vehicle 10 (hereinafter, referred to as the surrounding image) and the key frame map. The image self-position estimation unit 231 includes an image acquisition unit 241, a feature point detection unit 242, a range-of-use setting unit 243, a feature point checking unit 244, and a calculation unit 245.

The image acquisition unit 241 includes a fish-eye camera capable of capturing an image at an angle of view of 180 degrees or more by using a fish-eye lens, similarly to the image acquisition unit 221 of the key frame generation unit 211. As will be described later, the image acquisition unit 241 captures an image around (360 degrees) the upper side of the vehicle 10, and supplies the resulting surrounding image to the feature point detection unit 242.

The feature point detection unit 242 performs processing of detecting a feature point of the surrounding image, and supplies data indicating the detection results to the range-of-use setting unit 243.

The range-of-use setting unit 243 sets a range of use that is a range of an image to be used for self-position estimation processing in the surrounding image on the basis of the strength of a GNSS signal from a navigation satellite detected by a signal strength detection unit 252 of the GNSS self-position estimation unit 232. Specifically, as will be described later, in the image self-position estimation unit 231, self-position estimation is performed on the basis of the image in the range of use of the surrounding image. The range-of-use setting unit 243 supplies data indicating the detection results of the feature point of the surrounding image and data indicating the set range of use to the feature point checking unit 244.

The feature point checking unit 244 performs processing of checking features points of the surrounding image in the range of use against feature points of the key frame of the key frame map stored in the key frame map DB 212. The feature point checking unit 244 supplies data indicating the checking results of the feature point and data indicating the position and posture of the key frame used for the checking to the calculation unit 245.

The calculation unit 245 calculates the position and posture of the vehicle 10 in a map coordinate system on the basis of the data indicating the results of checking feature points of the surrounding image against feature points of the key frame and data indicating the position and posture of the key frame used for the checking. The calculation unit 245 supplies the data indicating the position and posture of the vehicle 10 to the final self-position estimation unit 233.

The GNSS self-position estimation unit 232 performs self-position estimation processing on the basis of a GNSS signal from a navigation satellite. The GNSS self-position estimation unit 232 includes a GNSS signal reception unit 251, the signal strength detection unit 252, and a calculation unit 253.

The GNSS signal reception unit 251 receives a GNSS signal from a navigation satellite, and supplies the received GNSS signal to the signal strength detection unit 252.

The signal strength detection unit 252 detects the strength of the received GNSS signal, and supplies data indicating the detection results to the final self-position estimation unit 233 and the range-of-use setting unit 243. Further, the signal strength detection unit 252 supplies the GNSS signal to the calculation unit 253.

The calculation unit 253 calculates the position and posture of the vehicle 10 in a map coordinate system on the basis of the GNSS signal. The calculation unit 253 supplies data indicating the position and posture of the vehicle 10 to the final self-position estimation unit 233.

The final self-position estimation unit 233 performs self-position estimation processing of the vehicle 10 on the basis of the self-position estimation results of the vehicle 10 by the image self-position estimation unit 231, the self-position estimation results of the vehicle 10 by the GNSS self-position estimation unit 232, and the strength of the GNSS signal. The final self-position estimation unit 233 supplies data indicating the results of the estimation processing to the map analysis unit 151, the traffic rule recognition unit 152, the situation recognition unit 153 shown in FIG. 1, and the like.

Note that in the case where the key frame generation unit 211 is provided not on the map generation vehicle but on the vehicle 10, i.e., the vehicle used for generating the key frame map and the vehicle that performs self-position estimation processing are the same, it is possible to communize the image acquisition unit 221 and the feature point detection unit 222 of the key frame generation unit 211, and the image acquisition unit 241 and the feature point detection unit 242 of the image self-position estimation unit 231, for example.

<Placement Example of Fish-Eye Camera>

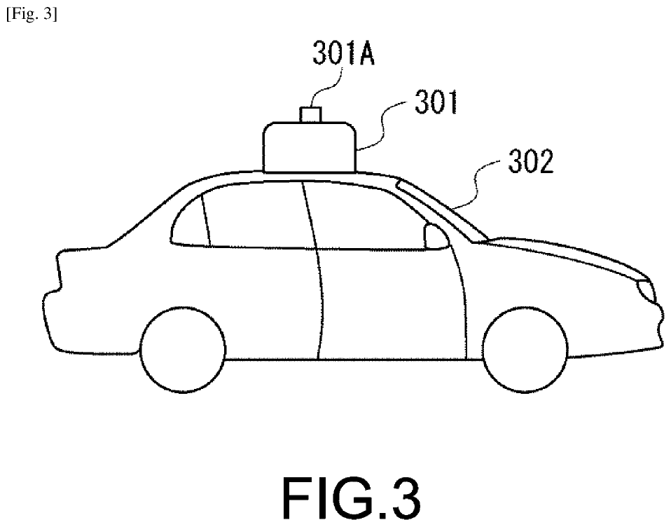

FIG. 3 is a diagram schematically showing a placement example of a fish-eye camera 301 included in the image acquisition unit 221 or the image acquisition unit 241 shown in FIG. 2.

The fish-eye camera 301 includes a fish-eye lens 301A, and the fish-eye lens 301A is attached to the roof of a vehicle 302 so that the fish-eye lens 301A is directed upward. Note that the vehicle 302 corresponds to the map generation vehicle or the vehicle 10.

Accordingly, the fish-eye camera 301 is capable of capturing an image around (360 degrees) the vehicle 302 around the upper side of the vehicle 302.

Note that the fish-eye lens 301A does not necessarily need to be directed right above (direction completely perpendicular to the direction in which the vehicle 302 moves forward), and may be slightly inclined from right above.

<Processing of Generating Key Frame>

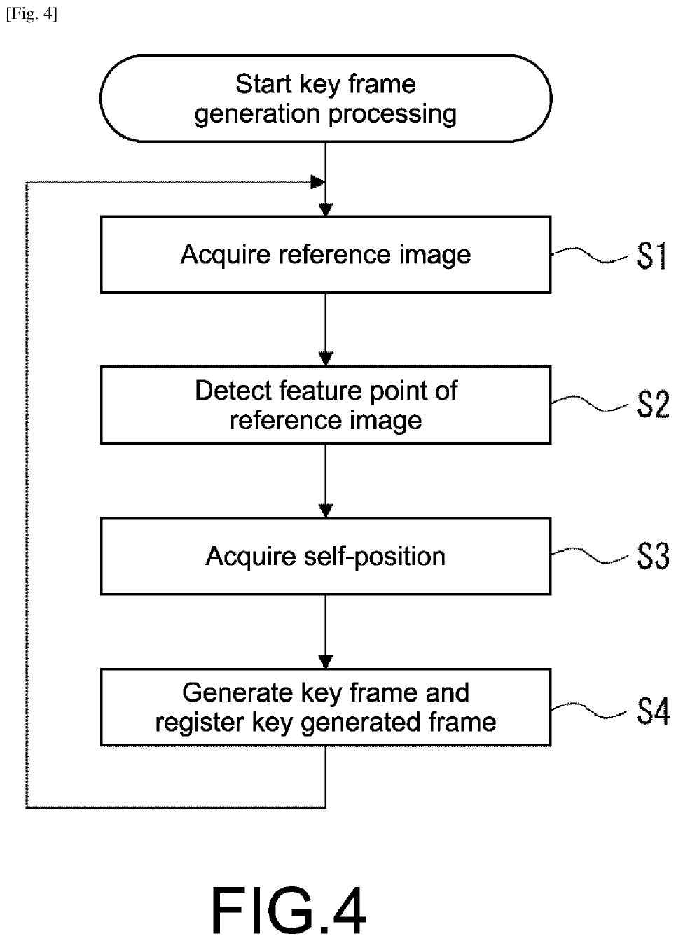

Next, key frame generation processing to be executed by the key frame generation unit 211 will be described with reference to the flowchart of FIG. 4. Note that this processing is started when the map generation vehicle is activated and performs an operation of starting driving, e.g., an ignition switch, a power switch, a start switch, or the like of the map generation vehicle is turned on. Further, this processing is finished when an operation of finishing the driving is performed, e.g., the ignition switch, the power switch, the start switch, or the like of the map generation vehicle is turned off.

In Step S1, the image acquisition unit 221 acquires a reference image. Specifically, the image acquisition unit 221 captures an image around (360 degrees) the upper side of the map generation vehicle and supplies the resulting reference image to the feature point detection unit 222.

In Step S2, the feature point detection unit 242 detects a feature point of the reference image, and supplies data indicating the detection results to the key frame registration unit 225.

Note that as the method of detecting the feature point, for example, an arbitrary method such as Harris corner can be used.

In Step S3, the self-position acquisition unit 223 acquires a self-position.

Specifically, the self-position acquisition unit 223 acquires data indicating the position and posture of the map generation vehicle in a map coordinate system by an arbitrary method, and supplies the acquired data to the key frame registration unit 225.

In Step S4, the key frame registration unit 225 generates a key frame, and registers the generated key frame. Specifically, the key frame registration unit 225 generates a key frame containing data indicating the position and feature amount in an image coordinate system of each feature point detected in the reference image, and data indicating the position and posture of the map generation vehicle in a map coordinate system at the time when the reference image is captured. The key frame registration unit 225 registers the generated key frame to the key frame map DB 212.

After that, the processing returns to Step S1, and the processing of Step S1 and subsequent Steps is executed.

Accordingly, a key frame is generated on the basis of a reference image captured at each area while the map generation vehicle runs, and registered in the key frame map.

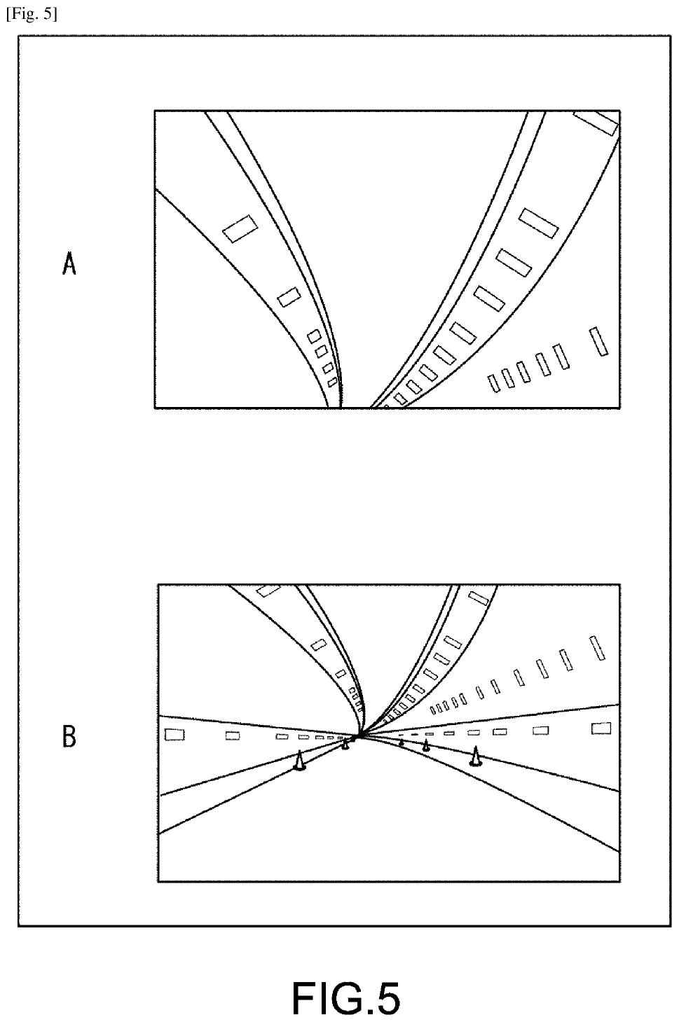

FIG. 5 to FIG. 7 each schematically show an example of comparing a case of capturing a reference image by using a wide-angle lens and a case of capturing a reference image by using a fish-eye lens. Parts A of FIG. 5 to FIG. 7 each show an example of a reference image captured using a wide-angle lens, and Parts B of FIG. 5 to FIG. 7 each show an example of a reference image captured using a fish-eye lens. Further, FIG. 5 to FIG. 7 each show an example of a reference image captured under an environment in which the surroundings (particularly, the upper side) of the map generation vehicle are surrounded by what is easy to block the GNSS signal and a reception error of a GNSS signal and reduction in reception strength easily occur.

Parts A and B of FIG. 5 each show an example of a reference image captured while running in a tunnel. In the tunnel, a GNSS signal is blocked by the ceiling or side walls of the tunnel, and a reception error of the GNSS signal and reduction in reception strength easily occur.

Further, since lights or the like are provided on the ceiling of the tunnel, the number of feature points detected near the center of the reference image (upper side of the map generation vehicle) is larger than that in the case of running in a place where the sky is open. Meanwhile, since many facilities such as lights and emergency equipment are provided near the right and left side walls of the tunnel, the density of the detected feature points is high. Therefore, by using a fish-eye lens having a wide angle of view, the detection amount of feature points in the reference image is significantly increased as compared with the case of using a wide-angle lens.

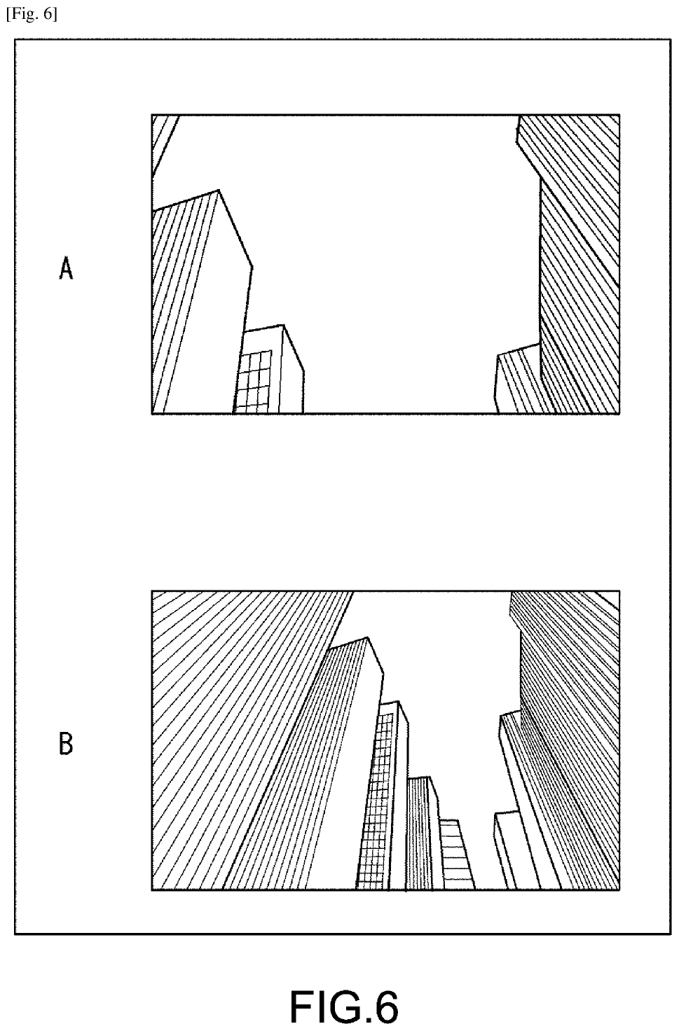

Parts A and B of FIG. 6 each show an example of a reference image captured while running through a high-rise building street. In the high-rise building street, a GNSS signal is blocked by the buildings, and a reception error of the GNSS signal and reduction in reception strength easily occur.

Further, since the upper floors of the buildings are included in the angle of view in the high-rise building street, the number of feature points detected near the center of the reference image (upper side of the map generation vehicle) is large as compared with the case of running in a place where the sky is open. Meanwhile, the lower the position, the higher the density of the buildings and the more constructions such as displays and signs. As a result, the density of the detected feature points is high. Therefore, by using a fish-eye lens having a wide angle of view, the detection amount of feature points in the reference image is significantly increased as compared with the case of using a wide-angle lens.

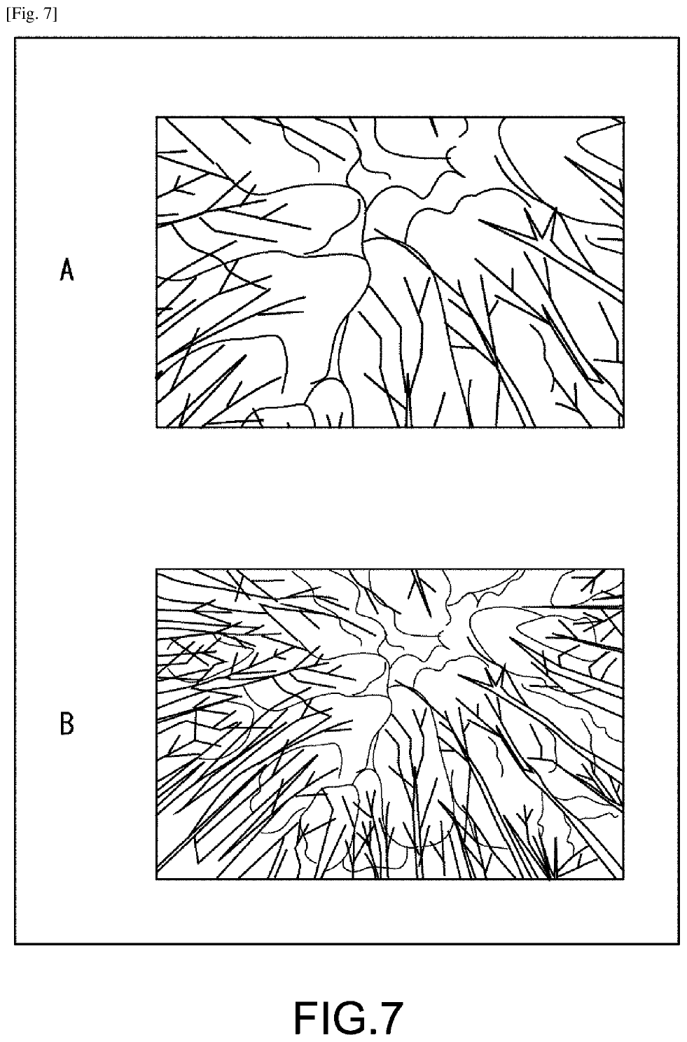

Parts A and B of FIG. 7 each show an example of a reference image captured while running in a forest. In the forest, a GNSS signal is blocked by trees, and a reception error of a GNSS signal and reduction in reception strength easily occur.

Since in the forest, a high part of the trees is included in an angle of view, the number of feature points detected near the center of the reference image (upper side of the map generation vehicle) is large as compared with the case of running in a place where the sky is open. Meanwhile, the lower the position, the higher the density of the trees (particularly trunks and branches). As a result, the density of the detected feature points is high. Therefore, by using a fish-eye lens having a wide angle of view, the detection amount of feature points in the reference image is significantly increased as compared with the case of using a wide-angle lens.

As described above, by capturing an image of the upper portion of the map generation vehicle by using a fish-eye lens, it is possible to capture a reference image with many feature points, which includes not only the upper side of the map generation vehicle but also the surroundings (360 degrees) of the map generation vehicle. As a result, it is possible to efficiently generate a useful key frame with more feature points.

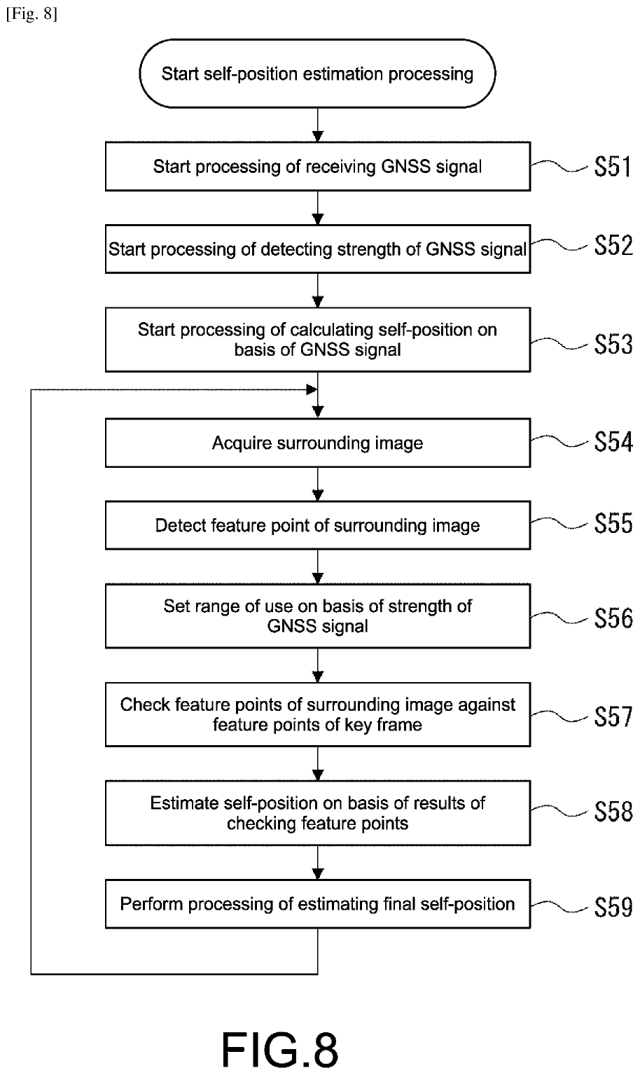

Next, self-position estimation processing to be executed by the self-position estimation processing unit 213 will be described with reference to the flowchart of FIG. 8. Note that this processing is started when the vehicle 10 is activated and performs an operation of starting driving, e.g., an ignition switch, a power switch, a start switch, or the like of the vehicle 10 is turned on. Further, this processing is finished when an operation of finishing the driving is performed, e.g., the ignition switch, the power switch, the start switch, or the like of the vehicle 10 is turned off.

In Step S51, the GNSS signal reception unit 251 starts processing of receiving a GNSS signal. Specifically, the GNSS signal reception unit 251 starts processing of receiving a GNSS signal from a navigation satellite, and supplying the received GNSS signal to the signal strength detection unit 252.

In Step S52, the signal strength detection unit 252 starts processing of detecting the strength of the GNSS signal. Specifically, the signal strength detection unit 252 starts processing of detecting the strength of the GNSS signal, and supplying data indicating the detection results to the final self-position estimation unit 233 and the range-of-use setting unit 243. Further, the signal strength detection unit 252 starts processing of supplying the GNSS signal to the calculation unit 253.

In Step S53, the calculation unit 253 starts processing of calculating a self-position on the basis of the GNSS signal. Specifically, the calculation unit 253 starts processing of calculating the position and posture of the vehicle 10 in a map coordinate system on the basis of the GNSS signal, and supplying data indicating the position and posture of the vehicle 10 to the final self-position estimation unit 233.

Note that as the method of calculating the position and posture of the vehicle 10 by the calculation unit 253, an arbitrary method can be used.

In Step S54, the image acquisition unit 241 acquires a surrounding image.

Specifically, the image acquisition unit 221 captures an image around (360 degrees) the upper side of the vehicle 10, and supplies the resulting surrounding image to the feature point detection unit 242.

In Step S55, the feature point detection unit 242 detects a feature point of the surrounding image. The feature point detection unit 242 supplies data indicating the detection results to the range-of-use setting unit 243.

Note that as the method of detecting the feature point, a method similar to that performed by the feature point detection unit 222 of the key frame generation unit 211 is used.

In Step S56, the range-of-use setting unit 243 sets a range of use on the basis of the strength of the GNSS signal.

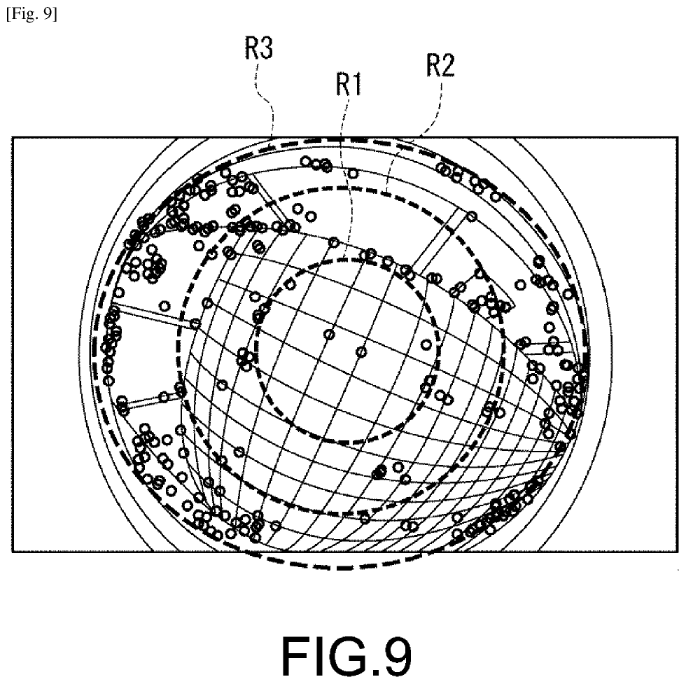

FIG. 9 schematically shows an example of the surrounding image acquired by the image acquisition unit 241. Note that this surrounding image shows an example of the surrounding image captured in a parking area in a building. Further, small circles in the image each represent a feature point detected in the surrounding image. Further, ranges R1 to R3 surrounded by dotted lines in FIG. 9 each show a concentric range centering on the center of the surrounding image. The range R2 extends in the outward direction as compared to the range R1, and includes the range R1. The range R3 extends in the outward direction as compared to the range R2, and includes the range R2.

As can be seen from the example of the surrounding image shown in FIG. 9 and examples of the reference image shown in FIG. 5 and FIG. 7, in the case of capturing an image of the upper side of the vehicle 10 by using a fish-eye lens, typically, the detected density of feature points tends to be higher in the lateral side (longitudinal and lateral directions) of the vehicle 10 than the upper side of the vehicle 10. Specifically, the closer to the center of the surrounding image (upper direction of the vehicle 10), the lower the density of the detected feature points. Further, the closer to the end portion (lateral side of the vehicle 10) of the surrounding image, the higher the density of the detected feature points.

Therefore, in the case of performing processing of checking features points of the surrounding image against feature points of the key frame, more feature points can be used by widening the range of use to the vicinity of the end portion of the surrounding image. Accordingly, the load and time necessary to check the feature points are reduced, and the possibility of failure in the checking is also reduced. As a result, the necessary time for self-position estimation processing by the image self-position estimation unit 231 can be reduced, and the possibility of failure in self-position estimation can also be reduced.

Meanwhile, since the surrounding image is captured by using a fish-eye lens, the distortion of the image becomes smaller as approaching the center potion of the surrounding image, and the distortion of the image becomes larger as approaching the end portion of the surrounding image. Therefore, in the case of performing processing of checking feature points of the surrounding image against feature points of the key frame, the checking accuracy is high when using only feature points near the center portion as compared with the case of using feature points away from the center portion. As a result, the accuracy of self-position estimation by the image self-position estimation unit 231 is improved.

On the contrary, the higher the strength of the GNSS signal, the lower the possibility of failure in self-position estimation by the GNSS self-position estimation unit 232. Further, the estimation accuracy is improved, and the reliability of the estimation results is also improved. Meanwhile, the lower the strength of the GNSS signal, the higher the possibility of failure in self-position estimation by the GNSS self-position estimation unit 232. Further, the estimation accuracy is reduced, and the reliability of the estimation results is also reduced.

In this regard, the range-of-use setting unit 243 narrows the range of use toward the center of the surrounding image as the strength of the GNSS signal is increased. Specifically, since the reliability of the self-position estimation results by the GNSS self-position estimation unit 232 becomes high, self-position estimation results with higher accuracy can be obtained even when the processing time of the image self-position estimation unit 231 is increased and the possibility of failure in estimation is increased.

Meanwhile, the range-of-use setting unit 243 widens the range of use toward the outside with reference to the center of the surrounding image as the strength of the GNSS signal is reduced. Specifically, since the reliability of the self-position estimation results by the GNSS self-position estimation unit 232 becomes high, self-position estimation results can be obtained more reliably and quickly even when the estimation accuracy by the image self-position estimation unit 231 is reduced.

Note that it is expected that there are many obstacles to block the GNSS signal on the upper side of the vehicle 10 in the case where the strength of the GNSS signal is low, and it is expected that there are few obstacles to block the GNSS signal on the upper side of the vehicle 10 in the case where the strength of the GNSS signal is high. As a result, in the case where the strength of the GNSS signal is low, it is expected that the detection amount of feature amounts is increased in the vicinity of the center where the distortion of the surrounding image is small as compared with the case where the strength of the GNSS signal is high. Therefore, in the case where the strength of the GNSS signal is low, it is expected that the reduction in accuracy of self-position estimation by widening the range of use is suppressed as compared with the case where the strength of the GNSS signal is high.

For example, the range-of-use setting unit 243 classifies the strength of the GNSS signal into three levels of a high level, a middle level, and a low level. Then, the range-of-use setting unit 243 sets the range of use to the range R1 shown in FIG. 9 in the case where the strength of the GNSS signal is the high level, the range of use to the range R2 shown in FIG. 9 in the case where the strength of the GNSS signal is the middle level, and the range of use to the range R3 shown in FIG. 9 in the case where the strength of the GNSS signal is the low level.

The range-of-use setting unit 243 supplies data indicating the detection results of the feature points of the surrounding image and data indicating the set range of use to the feature point checking unit 244.

In Step S57, the feature point checking unit 244 checks feature points of the surrounding image against feature points of the key frame. For example, the feature point checking unit 244 acquires a key frame, from key frames stored in the key frame map DB 212, based on the reference image captured at a position and posture close to the position and posture at which the surrounding image is captured. Then, the feature point checking unit 244 checks feature points of the surrounding image in the range of use and feature points of the key frame (i.e., feature points of the reference image captured in advance). The feature point checking unit 244 supplies data indicating the checking results of the feature point and data indicating the position and posture of the key frame used for the checking to the calculation unit 245.

In Step S58, the calculation unit 245 calculates a self-position on the basis of the checking results of the feature point. Specifically, the calculation unit 245 calculates the position and posture of the vehicle 10 in a map coordinate system on the basis of the results of checking feature points of the surrounding image against feature points of the key frame and the position and posture of the key frame used for the checking.

Note that as the method of calculating the position and posture of the vehicle 10 by the calculation unit 245, an arbitrary method can be used.

The calculation unit 245 supplies data indicating the position and posture of the vehicle 10 to the final self-position estimation unit 233.

In Step S59, the final self-position estimation unit 233 performs final self-position estimation processing. Specifically, the final self-position estimation unit 233 estimates the final position and posture of the vehicle 10 on the basis of the self-position estimation results by the image self-position estimation unit 231 and the self-position estimation results by the GNSS self-position estimation unit 232.

For example, since the reliability of the self-position estimation results by the GNSS self-position estimation unit 232 is increased as the strength of the GNSS signal is increased, the final self-position estimation unit 233 pays more attention to the self-position estimation results by the GNSS self-position estimation unit 232. Meanwhile, since the reliability of the self-position estimation results by the GNSS self-position estimation unit 232 is reduced as the strength of the GNSS signal is reduced, the final self-position estimation unit 233 pays more attention to the self-position estimation results by the image self-position estimation unit 231.

Specifically, for example, the final self-position estimation unit 233 adopts the self-position estimation result by the GNSS self-position estimation unit 232 in the case where the strength of the GNSS signal is greater than a predetermined threshold value. Specifically, the final self-position estimation unit 233 uses the position and posture of the vehicle 10 estimated by the GNSS self-position estimation unit 232 as the final estimation results of the position and posture of the vehicle 10.

Meanwhile, the final self-position estimation unit 233 adopts the self-position estimation result by the image self-position estimation unit 231 in the case where the strength of the GNSS signal is less than the predetermined threshold value. Specifically, the final self-position estimation unit 233 uses the position and posture of the vehicle 10 estimated by the image self-position estimation unit 231 as the final estimation results of the position and posture of the vehicle 10.

Alternatively, for example, the final self-position estimation unit 233 performs weighting addition on the self-position estimation results by the image self-position estimation unit 231 and the self-position estimation results by the GNSS self-position estimation unit 232 on the basis of the strength of the GNSS signal, and thereby estimates the final position and posture of the vehicle 10. At this time, for example, as the strength of the GNSS signal is increased, the weight for the self-position estimation results by the GNSS self-position estimation unit 232 is increased and the weight for the self-position estimation results by the image self-position estimation unit 231 is reduced. Meanwhile, as the strength of the GNSS signal is reduced, the weight for the self-position estimation results by the image self-position estimation unit 231 is increased and the weight for the self-position estimation results by the GNSS self-position estimation unit 232 is reduced.

After that, the processing returns to Step S54, and the processing of Step 54 and subsequent Steps is executed.

In this way, by using the surrounding image captured using a fish-eye lens, it is possible to improve the accuracy of estimating the self-position of the vehicle 10. For example, even in a place where the strength of the GNSS signal is low and the reliability of the self-position estimation by the GNSS signal is low, it is possible to estimate the position and posture of the vehicle 10 with high accuracy.

Further, since self-position estimation processing is performed using only a surrounding image obtained by capturing an image around (360 degrees) the vehicle 10 by using a fish-eye lens (a fish-eye camera), it is possible to reduce the processing load and processing time as compared with the case where a plurality of surrounding images obtained by capturing images around the vehicle by using a plurality of cameras are used.

<<3. Modified Examples>>

Hereinafter, modified examples of the above-mentioned embodiment of the present technology will be described.

For example, self-position estimation processing may be performed by providing, on the vehicle 10, a camera capable of capturing an image in the direction of the blind spot of a fish-eye lens and further using a surrounding image captured by the camera. Accordingly, the accuracy of the self-position estimation is improved.

Further, for example, a wiper dedicated to the fish-eye lens may be provided so that a surrounding image with high quality can be captured also in the case where the vehicle 10 runs under bad weather conditions such as rain, snow, and fog.

Further, although the example in which the position and posture of the vehicle 10 are estimated has been described above, the present technology can be applied to the case where only one of the position and posture of the vehicle 10 is estimated.

Further, the present technology can be applied to the case where self-position estimation of a movable object other than the vehicle illustrated above is performed.

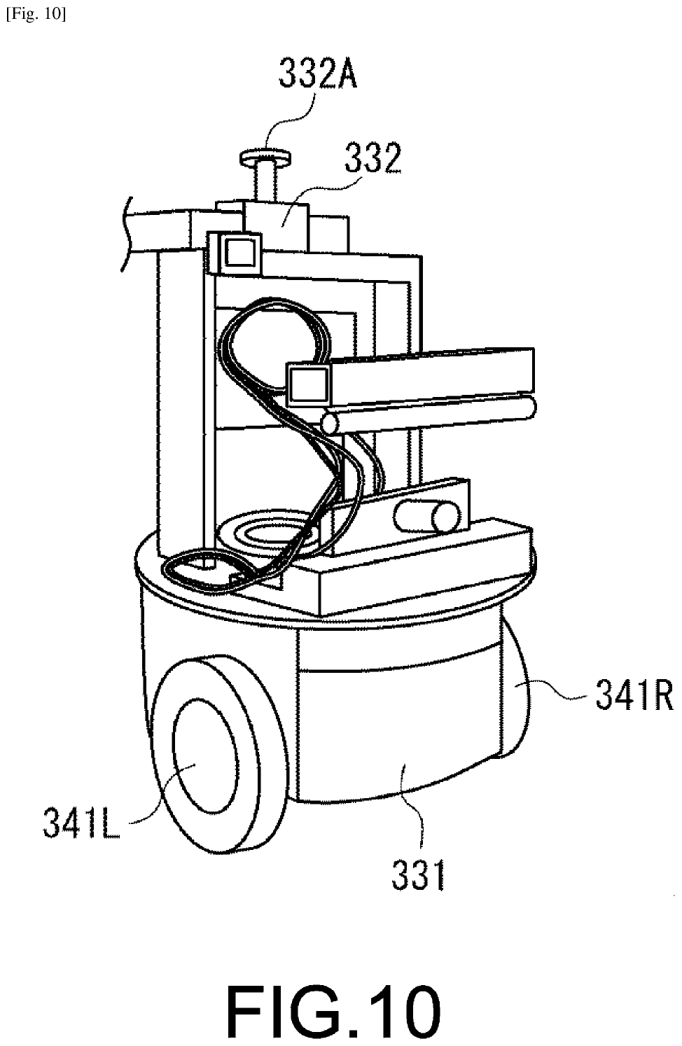

For example, as schematically shown in FIG. 10, the present technology can be applied also to the case where self-position estimation of a robot 331 capable of running by a wheel 341L and a wheel 341R is performed. In this example, a fish-eye camera 332 including a fish-eye lens 332A is attached to the upper end of the robot 331 to be directed upward.

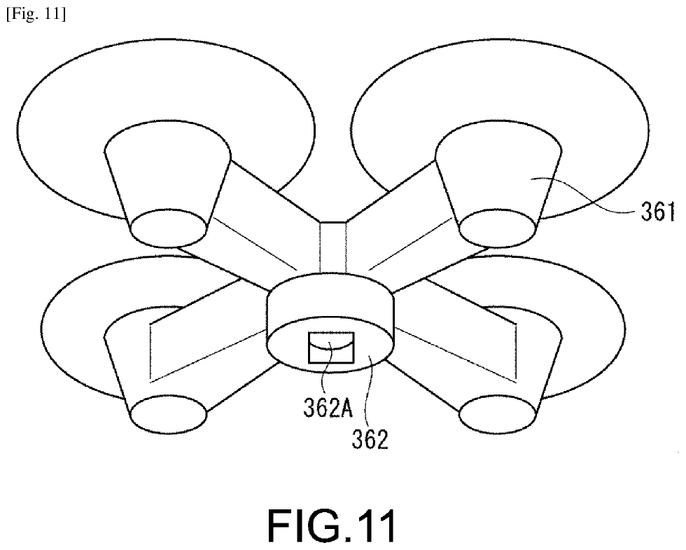

Further, for example, the present technology can be applied also to the case where self-position estimation of a flying object such as a drone 361 schematically shown in FIG. 11 is performed. Note that in the case of the drone 361, more feature point can be detected in the lower side (direction of the ground) of the drone 361 than the upper side (direction of the sky) of the drone 361. Therefore, in this example, a fish-eye camera 362 including a fish-eye lens 362A is attached to the lower surface of the body of the drone 361 to be directed downward.

Note that the fish-eye lens 362A does not necessarily need to be directed just downward (direction completely perpendicular to the direction in which the drone 361 moves forward), and may be slightly inclined from just downward.

Further, although the example in which a reference image captured using a fish-eye camera is used for generating a key frame has been described above, a reference image captured by a camera other than the fish-eye camera may be used. Note that since the surrounding image whose feature points are to be checked is captured by the fish-eye camera, it is favorable that also the reference image is captured by using a fish-eye camera.

Further, the present technology can be applied also to the case where self-position estimation is performed using a surrounding image captured using a fish-eye lens by a method other than feature point matching. Note that also in the case of using a method other than feature point matching, self-position estimation processing is performed on the basis of the image within the range of use of the surrounding image while changing the range of use depending on the strength of the GNSS signal, for example.

<<4. Others>>

<Configuration Example of Computer>

The series of processes described above can be performed by hardware or software. In the case where the series of processes are performed by the software, programs that constitute the software are installed in a computer. Examples of the computer include a computer incorporated in dedicated hardware, a general-purpose personal computer capable of executing various functions by installing various programs, and the like.

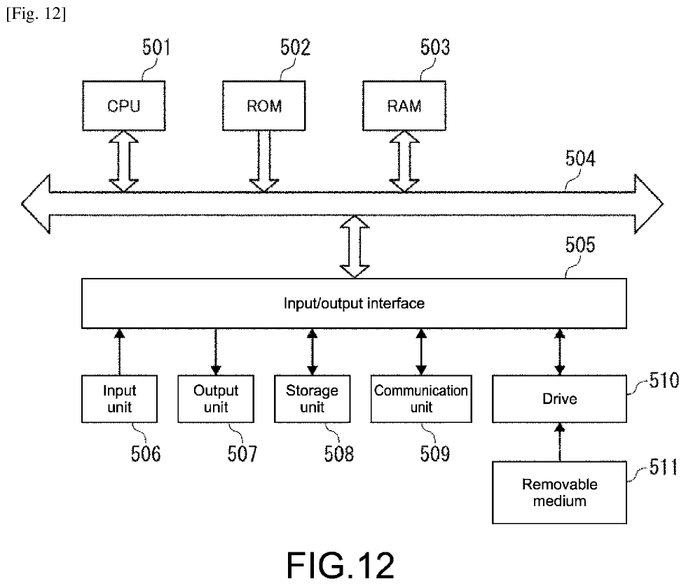

FIG. 12 is a block diagram showing a configuration example of the hardware of a computer that executes the series of processes described above by programs.

In a computer 500, a CPU (Central Processing Unit) 501, a ROM (Read Only Memory) 502, and a RAM (Random Access Memory) 503 are connected to each other via a bus 504.

To the bus 504, an input/output interface 505 is further connected. To the input/output interface 505, an input unit 506, an output unit 507, a storage unit 508, a communication unit 509, and a drive 510 are connected.

The input unit 506 includes an input switch, a button, a microphone, an image sensor, or the like. The output unit 507 includes a display, a speaker, or the like. The storage unit 508 includes a hard disk, a non-volatile memory, or the like. The communication unit 509 includes a network interface or the like. The drive 510 drives a removable medium 511 such as a magnetic disk, an optical disk, a magneto-optical disk, and a semiconductor memory.

In the computer 500 having the configuration as described above, for example, the CPU 501 loads a program stored in the storage unit 508 to the RAM 503 via the input/output interface 505 and the bus 504 and executes the program, thereby executing the series of processes described above.

The program executed by the computer 500 (CPU 501) can be provided by being recorded in the removable medium 511 as a package medium or the like, for example. Further, the program can be provided via a wired or wireless transmission medium, such as a local area network, the Internet, and a digital satellite broadcast.

In the computer 500, the program can be installed in the storage unit 508 via the input/output interface 505 by loading the removable medium 511 to the drive 510. Further, the program can be received by the communication unit 509 via a wired or wireless transmission medium and installed in the storage unit 508. In addition, the program can be installed in advance in the ROM 502 or the storage unit 508.

It should be noted that the program executed by the computer may be a program, the processes of which are performed in a chronological order along the description order in the specification, or may be a program, the processes of which are performed in parallel or at necessary timings when being called, for example.

Further, in the specification, the system refers to a set of a plurality of components (apparatuses, modules (parts), and the like). Whether all the components are in the same casing or not is not considered. Therefore, both of a plurality of apparatuses stored in separate casings and connected via a network and one apparatus having a plurality of modules stored in one casing are systems.

Further, the embodiments of present technology are not limited to the above-mentioned embodiments and can be variously modified without departing from the essence of the present technology.

For example, the present technology can have the configuration of cloud computing in which one function is shared by a plurality of apparatuses via a network and processed in cooperation with each other.

Further, the steps described in the flowchart described above can be executed by one apparatus or by a plurality of apparatuses in a sharing manner.

Further, in the case where one step includes a plurality of processes, the plurality of processes in the one step can be performed by one apparatus or shared by a plurality of apparatus.

<Combination Examples of Configurations>

It should be noted that the present technology can take the following configurations.

(1)

A computerized method for determining an estimated position of a movable object based on a received satellite signal, the method comprising:

determining, based on a received satellite signal, a range of use of an acquired image of an environment around the movable object; and

determining an estimated position of the movable object based on the range of use of the acquired image and a key frame from a key frame map.

(2)

The method according to (1), further comprising:

determining, based on the received satellite signal, (a) a strength of the satellite signal and (b) a first estimated position of a movable object based on the satellite signal;

detecting a set of feature points in the acquired image, wherein each feature point of the set of feature points comprises an associated location in the acquired image;

determining a second estimated position of the movable object based on a subset of feature points in the range of use of the acquired image and the key frame; and

determining the estimated position based on the first estimated position and the second estimated position.

(3)

The method according to (1), further comprising acquiring the acquired image, comprising acquiring a fish eye image of the environment around the movable object.

(4)

The method according to (3), wherein acquiring the fish eye image comprises acquiring the fish eye image in a direction extending upwards from a top of the movable object.

(5)

The method according to (3), wherein acquiring the fish eye image comprises acquiring the fish eye image in a direction extending downwards from a bottom of the movable object.

(6)

The method according to (1), further comprising receiving the satellite signal, wherein the satellite signal comprises a Global Navigation Satellite System signal.

(7)

An apparatus for determining an estimated position of a movable object based on a received satellite signal, the apparatus comprising a processor in communication with a memory, the processor being configured to execute instructions stored in the memory that cause the processor to:

determine, based on a received satellite signal, a range of use of an acquired image of an environment around the movable object; and

determine an estimated position of the movable object based on the range of use and a key frame from a key frame map.

(8)

The apparatus according to (7), wherein the instructions are further operable to cause the processor to:

determine, based on the received satellite signal, (a) a strength of the satellite signal and (b) a first estimated position of a movable object based on the satellite signal;

detect a set of feature points in the acquired image, wherein each feature point of the set of feature points comprises an associated location in the acquired image;

determine a second estimated position of the movable object based on a subset of feature points in the range of use of the acquired image and the key frame; and

determine the estimated position based on the first estimated position and the second estimated position.

(9)

The apparatus according to (7), further comprising a camera comprising a fish eye lens in communication with the processor, wherein the camera is configured to acquire the acquired image of the environment around the movable object.

(10)

The apparatus according to (9), wherein the camera is disposed on a top of the movable object, such that the camera is configured to acquire the acquired image in a direction extending upwards from a top of the movable object.

(11)

The apparatus according to (9), wherein the camera is disposed on a bottom of the movable object, such that the camera is configured to acquire the acquired image in a direction extending downwards from a bottom of the movable object.

(12)

The apparatus according to (7), further comprising a Global Navigation Satellite System receiver configured to receive the satellite signal, wherein the satellite signal comprises a Global Navigation Satellite System signal.

(13)

A non-transitory computer-readable storage medium comprising computer-executable instructions that, when executed by a processor, perform a method for determining an estimated position of a movable object based on a received satellite signal, the method comprising:

determining, based on a received satellite signal, a range of use of an acquired image of an environment around the movable object; and

determining an estimated position of the movable object based on the range of use and a key frame from a key frame map.

(14)

The non-transitory computer-readable storage medium according to (13), the method further comprising:

determining, based on the received satellite signal, (a) a strength of the satellite signal and (b) a first estimated position of a movable object based on the satellite signal;

detecting a set of feature points in the acquired image, wherein each feature point of the set of feature points comprises an associated location in the acquired image;

determining a second estimated position of the movable object based on a subset of feature points in the range of use of the acquired image and the key frame; and

determining the estimated position based on the first estimated position and the second estimated position.

(15)

The non-transitory computer-readable storage medium according to (13), the method further comprising acquiring the acquired image, comprising acquiring a fish eye image of the environment around the movable object.

(16)

The non-transitory computer-readable storage medium according to (15), wherein acquiring the fish eye image comprises acquiring the fish eye image in a direction extending upwards from a top of the movable object.

(17)

The non-transitory computer-readable storage medium according to (15), wherein acquiring the fish eye image comprises acquiring the fish eye image in a direction extending downwards from a bottom of the movable object.

(18)

The non-transitory computer-readable storage medium according to (13), the method further comprising receiving the satellite signal, wherein the satellite signal comprises a Global Navigation Satellite System signal.

(19)

A movable object configured to determine an estimated position of the movable object based on a received satellite signal, the movable object comprising a processor in communication with a memory, the processor being configured to execute instructions stored in the memory that cause the processor to:

determine, based on a received satellite signal, a range of use of an acquired image of an environment around the movable object; and

determine an estimated position of the movable object based on the range of use and a key frame from a key frame map.

(20)

The movable object according to (19), wherein the instructions are further operable to cause the processor to:

determine, based on the received satellite signal, (a) a strength of the satellite signal and (b) a first estimated position of a movable object based on the satellite signal;

detect a set of feature points in the acquired image, wherein each feature point of the set of feature points comprises an associated location in the acquired image;

determine a second estimated position of the movable object based on a subset of feature points in the range of use of the acquired image and the key frame; and

determine the estimated position based on the first estimated position and the second estimated position.

It should be noted that the effect described here is not necessarily limitative and may be any effect described in the present disclosure.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 vehicle

100 vehicle control system

132 self-position estimation unit

141 vehicle exterior information detection unit

201 self-position estimation system

211 key frame generation unit

212 key frame map DB

213 self-position estimation processing unit

231 image self-position estimation unit

232 GNSS self-position estimation unit

233 final self-position estimation unit

241 image acquisition unit

242 feature point detection unit

243 range-of-use setting unit

244 feature point checking unit

245 calculation unit

252 signal strength detection unit

301 fish-eye camera

301A fish-eye lens

302 vehicle

331 robot

332 fish-eye camera

332A fish-eye lens

361 drone

362 fish-eye camera

362A fish-eye lens

1. A computerized method for determining an estimated position of a movable object based on a received satellite signal, the method comprising:
determining, based on a received satellite signal, a range of use of an acquired image of an environment around the movable object; and
determining an estimated position of the movable object based on the range of use of the acquired image and a key frame from a key frame map.

2. The method of claim 1, further comprising:
determining, based on the received satellite signal, (a) a strength of the satellite signal and (b) a first estimated position of a movable object based on the satellite signal;
detecting a set of feature points in the acquired image, wherein each feature point of the set of feature points comprises an associated location in the acquired image;
determining a second estimated position of the movable object based on a subset of feature points in the range of use of the acquired image and the key frame; and
determining the estimated position based on the first estimated position and the second estimated position.

3. The method of claim 1, further comprising acquiring the acquired image, comprising acquiring a fish eye image of the environment around the movable object.

4. The method of claim 3, wherein acquiring the fish eye image comprises acquiring the fish eye image in a direction extending upwards from a top of the movable object.

5. The method of claim 3, wherein acquiring the fish eye image comprises acquiring the fish eye image in a direction extending downwards from a bottom of the movable object.

6. The method of claim 1, further comprising receiving the satellite signal, wherein the satellite signal comprises a Global Navigation Satellite System signal.

7. An apparatus for determining an estimated position of a movable object based on a received satellite signal, the apparatus comprising a processor in communication with a memory, the processor being configured to execute instructions stored in the memory that cause the processor to:
determine, based on a received satellite signal, a range of use of an acquired image of an environment around the movable object; and
determine an estimated position of the movable object based on the range of use and a key frame from a key frame map.

8. The apparatus of claim 7, wherein the instructions are further operable to cause the processor to:
determine, based on the received satellite signal, (a) a strength of the satellite signal and (b) a first estimated position of a movable object based on the satellite signal;
detect a set of feature points in the acquired image, wherein each feature point of the set of feature points comprises an associated location in the acquired image;
determine a second estimated position of the movable object based on a subset of feature points in the range of use of the acquired image and the key frame; and
determine the estimated position based on the first estimated position and the second estimated position.

9. The apparatus of claim 7, further comprising a camera comprising a fish eye lens in communication with the processor, wherein the camera is configured to acquire the acquired image of the environment around the movable object.

10. The apparatus of claim 9, wherein the camera is disposed on a top of the movable object, such that the camera is configured to acquire the acquired image in a direction extending upwards from a top of the movable object.

11. The apparatus of claim 9, wherein the camera is disposed on a bottom of the movable object, such that the camera is configured to acquire the acquired image in a direction extending downwards from a bottom of the movable object.

12. The apparatus of claim 7, further comprising a Global Navigation Satellite System receiver configured to receive the satellite signal, wherein the satellite signal comprises a Global Navigation Satellite System signal.

13. A non-transitory computer-readable storage medium comprising computer-executable instructions that, when executed by a processor, perform a method for determining an estimated position of a movable object based on a received satellite signal, the method comprising:
determining, based on a received satellite signal, a range of use of an acquired image of an environment around the movable object; and
determining an estimated position of the movable object based on the range of use and a key frame from a key frame map.

14. The non-transitory computer-readable storage medium of claim 13, the method further comprising:
determining, based on the received satellite signal, (a) a strength of the satellite signal and (b) a first estimated position of a movable object based on the satellite signal;
detecting a set of feature points in the acquired image, wherein each feature point of the set of feature points comprises an associated location in the acquired image;
determining a second estimated position of the movable object based on a subset of feature points in the range of use of the acquired image and the key frame; and
determining the estimated position based on the first estimated position and the second estimated position.

15. The non-transitory computer-readable storage medium of claim 13, the method further comprising acquiring the acquired image, comprising acquiring a fish eye image of the environment around the movable object.

16. The non-transitory computer-readable storage medium of claim 15, wherein acquiring the fish eye image comprises acquiring the fish eye image in a direction extending upwards from a top of the movable object.

17. The non-transitory computer-readable storage medium of claim 15, wherein acquiring the fish eye image comprises acquiring the fish eye image in a direction extending downwards from a bottom of the movable object.

18. The non-transitory computer-readable storage medium of claim 13, the method further comprising receiving the satellite signal, wherein the satellite signal comprises a Global Navigation Satellite System signal.

19. A movable object configured to determine an estimated position of the movable object based on a received satellite signal, the movable object comprising a processor in communication with a memory, the processor being configured to execute instructions stored in the memory that cause the processor to:
determine, based on a received satellite signal, a range of use of an acquired image of an environment around the movable object; and
determine an estimated position of the movable object based on the range of use and a key frame from a key frame map.

20. The movable object of claim 19, wherein the instructions are further operable to cause the processor to:
determine, based on the received satellite signal, (a) a strength of the satellite signal and (b) a first estimated position of a movable object based on the satellite signal;
detect a set of feature points in the acquired image, wherein each feature point of the set of feature points comprises an associated location in the acquired image;
determine a second estimated position of the movable object based on a subset of feature points in the range of use of the acquired image and the key frame; and
determine the estimated position based on the first estimated position and the second estimated position.
